(19) United States
(12) Patent Application Publication
(10) Pub. No.: US 2015/0149775 A1
(43) Pub. Date: May 28, 2015

(54) Method and System of Secure Email

(71) Applicant: POWA Technologies (Hong Kong) Limited, Hong Kong (HK)

(72) Inventor: Alessandro GADOTTI, Hong Kong (HK)

(21) Appl. No.: 14/554,069

(22) Filed: Nov. 26, 2014

Related U.S. Application Data
(60) Provisional application No. 61/908,759, filed on Nov. 26, 2013.

(51) Int. Cl. H04L 29/06; H04L 12/58

(52) U.S. Cl. CPC H04L 63/0428; H04L 51/04
USPC 713/168

(57) ABSTRACT

A process of sending and receiving emails using uniquely associated mobile communication devices involving a sender and a recipient, both registered users in a secure email communication system. The use of uniquely associated mobile communication devices with additional user authentication in the email sending and receiving ensures the authenticity of the sender and the recipient. Furthermore, the process of sending and receiving emails through the secure email communication system includes multiple levels of encryption and decryption of emails.

### CLAIM FOR DOMESTIC PRIORITY

This application claims priority under 35 U.S.C. §119 to the U.S. Provisional Patent Application No. 61/908,759, filed Nov. 26, 2013, the disclosure of which is incorporated herein by reference in its entirety.

### CROSS-REFERENCES TO RELATED APPLICATIONS

This application is a continuation-in-part application of the U.S. patent application Ser. No. 13/602,197 filed Sep. 2, 2012, the disclosure of which is incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to methods and systems of sending and receiving secure electronic mail. More specifically, the present invention relates to methods and systems sending and receiving secure electronic mail with the use of mobile communication devices and computer generated barcodes.

### BACKGROUND

Electronic mail (email) has become prevalent and the preferred tool of personal and business communication in today's societies. However, numerous security issues continue to plague the use of e-mail and the technology itself. Authenticity and privacy are the two primary areas under the most serious treats when either or both the sender and recipient lack a secure and reliable communication channel. For example, there often arise questions from the email sender such as: 1.) Did the recipient really open the email message? 2.) Did anybody intercept the email message? 3.) How can I prevent the recipient to forward the email message that is meant for the intended recipient's eyes only? 4.) Is the recipient who she claimed to be? 5.) Did the recipient receive the same email message as what I wrote? And from the email recipient side, questions include: 1.) Is the sender who she claimed to be? 2.) Did the sender really send the email message? 3.) Is the email message really what the sender wrote?

### SUMMARY

It is an objective of the presently claimed invention to provide a method and system for sending and receiving emails securely. It is a further objective of the presently claimed invention to provide such method and system that can leverage existing mobile communication devices and communication infrastructures, and does not require a dedicated infrastructure of hardware or network. In accordance with various embodiments, the present invention incorporates the secure mobile payment method and system disclosed in U.S. patent application Ser. No. 13/602,197.

In accordance with various embodiments, the present invention comprises a system of secure email communication comprising a first central processing server accessible through a first communication network, which can be the Internet, a telecommunication network, or any network supporting the TCP/IP protocol; a plurality of email users, each associated with a user account with records stored I the first central processing server; mobile communication devices each associated with one of the email users; optionally computing devices used for sending and/or receiving emails, wherein the computing devices include, but not limited to, desktop computers, laptop computers, tablet computers; a second central processing server accessible through the first communication network; and a third party central processing server.

In accordance to various embodiments, the method of secure email communication comprises a user account setup process, wherein the user account setup process comprises the steps of user registration, user validation, user profile management, funding source and fund-receiving destination management, and device pairing. A mobile communication device equipped with a camera or barcode scanner must be associated (paired) with a user's user account. Only one mobile communication device can be paired with a user account at any one time.

In accordance to various embodiments, the present invention comprises a process of sending and receiving emails using uniquely associated mobile communication devices involving a sender and a recipient, both registered users in the secure email communication system. The use of uniquely associated mobile communication devices with additional user authentication in the email sending and receiving ensures the authenticity of the sender and the recipient. Furthermore, the process of sending and receiving emails through the secure email communication system includes multiple levels of encryption and decryption of emails.

### BRIEF DESCRIPTION OF THE DRAWINGS

Embodiments of the invention are described in more detail hereinafter with reference to the drawings, in which

FIG. 1 shows a block diagram illustrating an exemplary embodiment of the presently claimed system of secure email communication;

FIG. 2 depicts a logical flow diagram illustrating a process of sending and receiving an email with the sender and recipient using their mobile communication devices in accordance to one embodiment of the present invention;

FIGS. 3A and 3B depict a logical flow diagram illustrating a process of sending and receiving an email with the sender and recipient using their using their computing devices in accordance to one embodiment of the present invention;

FIG. 4 shows the user interface of the secure email mobile application running in the sender's mobile communication device being used to send a secure email and the user interface of the secure email mobile application running in the recipient's mobile communication device being used to receive the secure email in accordance to one embodiment of the present invention;

FIG. 5 shows the user interface of the secure email mobile application running in the sender's mobile communication device being used to send a secure email with attachment and the user interface of the secure email mobile application running in the recipient's mobile communication device being used to receive the secure email with attachment in accordance to one embodiment of the present invention;

FIG. 6 shows the user interface of the secure email mobile application running in the recipient's mobile communication device being used to counter-sign an attached document in a secure email received and the user interface of the secure email mobile application running in the sender's mobile communication device being used to receive a message indicating the recipient's counter-signing of the attached document in accordance to one embodiment of the present invention;

FIG. 7 shows the user interface of the secure email mobile application running in the recipient's mobile communication device being used to counter-sign and comment an attached document in a secure email received and the user interface of the secure email mobile application running in the sender's mobile communication device being used to receive a reply email from the recipient with the counter-signed and commented attached document in accordance to one embodiment of the present invention; and

FIG. 8 shows the user interface of the secure email mobile application running in a mobile communication device being used to verify a signed document in accordance to one embodiment of the present invention.

### DETAILED DESCRIPTION

In the following description, methods and systems of secure email communication and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

System:

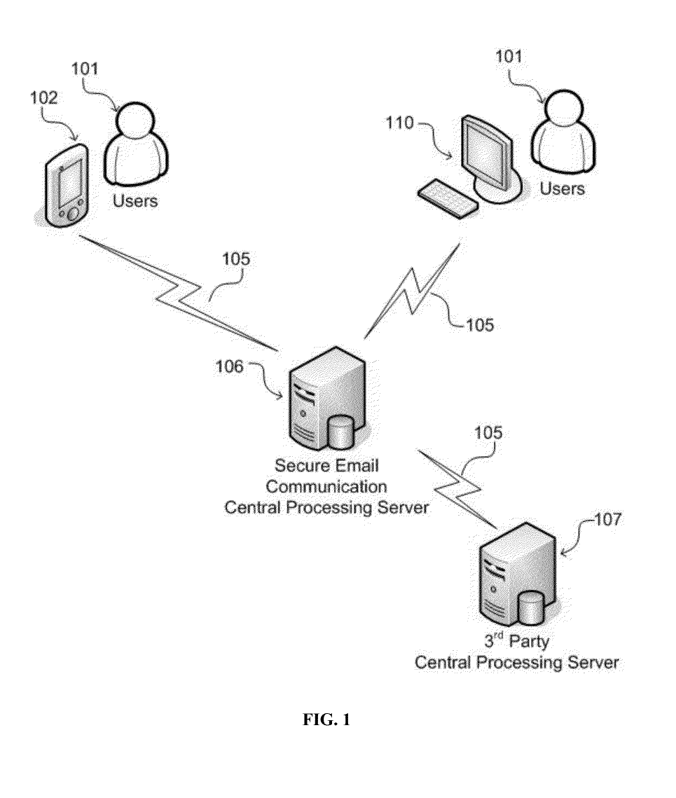

Referring to FIG. 1. In accordance with various embodiments, the presently claimed secure email communication system comprises a first central processing server 106 accessible through a first communication network 105, which can be the Internet, a telecommunication network, or any network supporting the TCP/IP protocol; a plurality of users 101, each associated with a user account with records stored I the first central processing server 106; mobile communication devices 102 each associated with one of the users 101; optionally computing devices 104 used for displaying, creating, sending, and/or receiving emails, wherein the computing devices 104 include, but not limited to, desktop computers, laptop computers, tablet computers; and a third party central processing server 107. Optionally, the mobile communication devices 102 communicate with the first central processing server 106 through the first communication network 105 under data encryption in accordance to the 256-bit Secure Sockets Layer (SSL) encryption.

In accordance with one aspect of the presently claimed secure email communication system, the functionalities of the first central processing server 106 comprises; user account management for managing user accounts and authenticating users, wherein a data record of a user account comprises a least the user's identification and authentication information; facilitating the transport of emails (i.e. executing a email server application based on the Simple Mail Transfer Protocol—SMTP); facilitating the messaging to and from the users' mobile communication devices and computing devices; and storing the email messages and attachments. In accordance with one embodiment, the first central processing server 106 is the central processing server of the secure mobile payment system disclosed in U.S. patent application Ser. No. 13/602,197.

In accordance with another aspect of the presently claimed secure email communication system, the first central processing server 106 includes one or more user interfaces for users accessible by the mobile communication devices 102 and other computing devices through the first communication network 105; the user interfaces include interactive transactional web sites that can be displayed in web browser applications running in the mobile communication devices 102 and other computing devices, and user interfaces that are specifically designed for specifically-developed software applications running in the mobile communication devices 102 and other computing devices. One exemplary embodiment of such user interface is a mobile application (App) running on the iOS operating system developed by Apple® Inc. Another exemplary embodiment of such user interface is a mobile application (App) running on the Android operating system developed by Google Inc.

In addition to the user interfaces, the first central processing server 106 also includes server backend APIs for machine-to-machine integration, enabling specifically-developed software applications running in mobile communication devices or other computing devices to communicate with the first central processing server 106. In accordance to various embodiments, the machine-to-machine data interchanges via the secure mobile payment server backend APIs supports industry standards including, but are limited to, XML and JSON.

These user interfaces and the server backend APIs facilitate the functionalities including, but are not limited to, user account management, user authentication, system administration by administrators, transporting of emails, messaging to and from the users' mobile communication devices and computing devices; storage and retrieval of the email messages and attachments.

In accordance with another aspect of the presently claimed secure email communication system, the first central processing server 106 includes a data repository for preserving data records of the user accounts, email messages and attachments, system configuration data, and other meta data. The data repository can be implemented in the same physical computer server of the first central processing server 106, or in a separate physical computer server connected to the first central processing server 106 through a private communication network or the Internet. Exemplary embodiments of the data repository are various commercially available relational database management systems such as Oracle® Database and Microsoft® SQL Server.

In accordance with one aspect of the presently claimed secure email communication system, each user account in the secure email communication system may associate (pair) with only a single user's mobile communication device at any one time. Each of the users 101 is required to define a security personal identification number (PIN) for his/her user account according to the system configuration.

In accordance with various embodiments, each of the mobile communication devices 102 is equipped with a camera or scanner for optically capturing images of computer-generated barcodes. In accordance with various embodiments, the mobile communication device is configured to process the captured barcode image and enable the secure email process including encrypting, decrypting, displaying, creating, sending and receiving emails by connecting and exchanging data with the email server applications running in the first central processing server 106 and/or the third party central processing server 107 (under i.e. the Post Office Protocol—POP3 and/or Internet Message Access Protocol—IMAP). In accordance with various embodiments, the mobile communication device configuration is accomplished by installing and executing application software and/or firmware specifically designed for the mobile communication device (hereinafter referred to as “secure email mobile application”) in the mobile communication device. Optionally, the operating system of the mobile communication device is modified and/or configured to accomplish portions or all of the aforementioned functionalities.

In accordance with various embodiments, the computer-generated barcode is a matrix or two-dimensional barcode such as a Quick Response (QR) code. The barcode can be generated by the first central processing server 106, the mobile communication devices 102 running the secure email mobile application, or a third party system. The barcode contains at least an identity data, which is unique to each barcode at least within the secure email communication system if not globally. The barcode can be used to identify and verify the authenticity of a message or document that it associated with. The barcode can be embedded in the content of an email message and/or its attached document.

In accordance with various embodiments, the computing devices 104 are optional components in the presently claimed secure email system. A user of the secure email communication system may choose to use one of computing devices 104, which can be a desktop personal computer, laptop computer, or tablet computer, running an email client application or browser application for displaying, creating, sending and receiving emails by connecting and exchanging data with the email server applications running in the first central processing server 106 and/or the third party central processing server 107 (under i.e. the Post Office Protocol—POP3 and/or Internet Message Access Protocol—IMAP).

In accordance with various embodiments, the third party central processing server 107 executes a email server application for a third party email provider such as a commercial paid or free email provider such as Hotmail® and Gmail®, or an enterprise's own private email server.

In accordance with one embodiment, each of the computing devices 104 displays, creates, sends, and/or receives emails using a browser software application (accessing a web-based email client) or email client software application augmented with or modified by a secure email software plug-in component, wherein the secure email software plug-in component encrypts and decrypts the email messages being displayed or composed in the browser software application or email client software application, and communicates with the first central processing server 106. The secure email software plug-in component also provides the user interface elements to facilitate features such as allowing the user to authenticate, specify restriction on email forwarding, and sign email messages and attached documents.

In accordance with another embodiment, each of the computing devices 104 displays, creates, sends, and/or receives emails using a specially developed secure email software application, wherein the secure email software application encrypts and decrypts the email messages being displayed or composed, and communicates with the first central processing server 106. The secure email software application also provides the user interface elements to facilitate features such as allowing the user to authenticate, specify restriction on email forwarding, and sign email messages and attached documents.

User Account Setup:

In accordance to various embodiments, the method of secure email communication comprises a user account setup process, wherein the user account setup process comprises the steps of user registration, user validation, user profile management, funding source and fund-receiving destination management, and device pairing as listed below:

User Registration:

1. A new user accesses the first central processing server user interface using a computing device with a browser software application or a mobile communication device configured to access the first central processing server user interface.
2. The new user selects create user account action in the first central processing server user interface, provides his/her personal information including at least his/her first name, last name, and email address, a mobile phone number including the country code, and provides a password for subsequently signing into the first central processing server.
3. The new user is also asked to select from a list of security questions, such as “Where did you travel on your honeymoon?” and “What is the name of your first pet?”, and provide the answer to the chosen security question. Lastly, the new user is asked to provide the answer to a qualifying question, such as a portion of a government issued identification number.

User Validation:

4. The first central processing server sends a validation email to the email address provided by the new user.
5. The newly created user account is validated by the new user receiving and reading the validation email, and accessing a validation web hyperlink, which bears the new user's personal identification data within, in the validation email.
6. The access action of the validation web hyperlink sends the new user's personal identification data to the first central processing server; and upon the receipt of this data, the validation of the newly created user account is completed, and the new user is notified as such.

User Profile Management:

7. After the newly created user account is validated, the new user can access his/her user account by accessing the first central processing server user interface and signing in using his/her email address, mobile phone number, and password.
8. After signing into his/her user account, the new user can enter and modify his/her user profile information including, but is not limited to, name, email address, residence address, business address, delivery address, and mobile phone number for being saved and associated with his/her user account.

Device Pairing:

15. A mobile communication device equipped with a camera or barcode scanner must be associated (paired) with the new user's user account. Only one mobile communication device can be paired with a user account at any one time. If a user account is already paired with a mobile communication device, it must be unpaired before another mobile communication device is paired with the user account.
16. The new user configures his/her mobile communication device to be able to access the first central processing server user interface. In one exemplary embodiment, the new user uses his/her mobile communication device to access a mobile application store, find, download, and install the secure email mobile application, which is specifically designed to interact with the first central processing server, in his/her mobile communication device. By launching and interacting with the secure email mobile application running in his/her mobile communication device, the new user can access the first central processing server to initiate the pairing process.
17. Using the secure email mobile application running in his/her mobile communication device, the new user signs in to his/her user account using his/her email, mobile phone number, and password that are registered in a prior user registration. The user authentication information is sent to the first central processing server for authentication along with the mobile communication device's identification data.
18. The first central processing server authenticates the new consumer user. Upon a positive authentication, the first central process server identifies that the mobile communication device is not yet paired with the user account, replies with the previously chosen security question and qualifying question to the mobile communication device running the secure email mobile application.
19. The new user is prompted to enter an answer to the security question and an answer to the qualifying question; and the answers are sent to the first central processing server.
20. The first central processing server verifies the security answer and the qualifying answer. Upon a positive verification, the first central processing server sends the mobile communication device a SMS message communication containing an activation code.
21. Upon receiving the SMS message communication and the activation code contained within, the new user enters the activation code and a user-defined security PIN in the secure email mobile application. In one embodiment, the security PIN can be a 4, 5, or 6-digit number combination.
22. The secure email mobile application performs a cryptographic hash operation on the security PIN received. The activation code and the cryptographic hash of the security PIN are sent to the first central processing server for verification and storage.
23. The secure email mobile application also sends the device ID, which is a distinct identification number associated with the mobile communication device, to the first central processing server and be stored for later use.
24. The first central processing server then generates a pair of public and private keys in accordance to the Public Key Infrastructure (PKI) encryption scheme. The private key is sent to the mobile communication device and stored for future use. The public key is stored in the first central processing server along under the user account record, completing the device pairing process.

In accordance to one embodiment, the user account setup process in the present invention is substantially the same as the user account setup process disclosed in U.S. patent application Ser. No. 13/602,197.

Sending and Receiving Secure Email Using Paired Mobile Communication Devices:

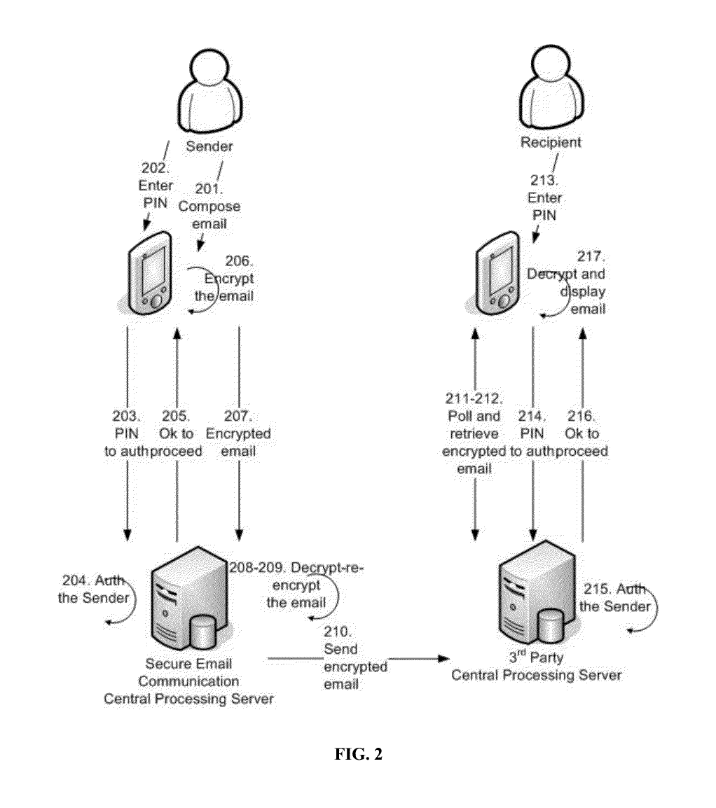

Referring to FIG. 2. The process of sending and receiving emails using paired mobile communication devices involving a sender and a recipient, both registered users in the secure email communication system, comprising the following steps:

1. (201) Using her paired mobile communication device running the secure email mobile application, the sender composes an email in the secure email mobile application user interface, specifies the email address of the recipient, selects the email forwarding restriction option, and commands the secure email mobile application to send the email. Optionally, the sender can command the secure email mobile application to attach a document that is previously stored in the mobile communication device or the first central processing server to the email. In addition, the sender can command the secure email mobile application to electronically sign the attached document.
2. (202) The secure email mobile application prompts the sender to enter her security PIN in the secure email mobile application user interface to be cryptographically hashed by the secure email mobile application.
3. (203) The sender's mobile communication device running the secure email mobile application sends the cryptographically hash of the sender's security PIN, and the sender's mobile communication device's device ID to the first central processing server.
4. (204) The first central processing server authenticates the sender using the cryptographically hash of security PIN and the sender's mobile communication device's device ID received.
5. (205) Upon positive authentication, the first central processing server notifies the sender's mobile communication device to proceed, sending to sender's mobile communication device along with the sender's private key retrieved from the sender's user account record.
6. (206) The secure email mobile application running in the sender's mobile communication device encrypts the email message using the sender's private key and the device ID of the sender's mobile communication device.
7. (207) The secure email mobile application sends the encrypted email to the first central processing server under SMTP protocol to be processed by the email server application running in the first central processing server.
8. (208) The first central processing server decrypts the received encrypted email using the sender's public key that is previously saved in the first central processing server and the device ID of the sender's mobile communication device that is previously saved in the first central processing server.
9. (209) The first central processing server extracts the recipient's email address from the email message, finds and retrieves the recipient's user account record using the recipient's email address from its database, and in turn retrieves the recipient's public key and the device ID of the recipient's mobile communication device from the recipient's user account record. The first central processing server re-encrypts the email message again using the recipient's public key and the device ID of the recipient's mobile communication device.
10. (210) The first central processing server sends the re-encrypted email to the third party central processing server running the email server application that hosts the recipient's email address as specified in the email under the SMTP protocol.
11. (211) The secure email mobile application running in the recipient's paired mobile communication device polls the email server application running in the third party central processing server under the POP3 or IMAP protocol for new email.
12. (212) The secure email mobile application running in the recipient's mobile communication device retrieves the re-encrypted email from the third party central processing server.
13. (213) The recipient commands the secure email mobile application to decrypt the received re-encrypted email. The secure email mobile application prompts the recipient to enter her security PIN in the secure email mobile application user interface to be cryptographically hashed by the secure email mobile application.
14. (214) The recipient's mobile communication device running the secure email mobile application sends the cryptographically hash of the recipient's security PIN, and the recipient's mobile communication device's device ID to the first central processing server.
15. (215) The first central processing server authenticates the recipient using the cryptographically hash of security PIN and the recipient's mobile communication device's device ID received.
16. (216) Upon positive authentication, the first central processing server notifies the recipient's mobile communication device to proceed, sending to recipient's mobile communication device along with the recipient's private key retrieved from the recipient's user account record.
17. (217) The secure email mobile application running in the recipient's mobile communication device decrypts the re-encrypted email using the recipient's private key and the device ID of the recipient's mobile communication device, and displays the decrypted email message as commanded by the recipient.

Sending and Receiving Secure Email Using Computing Devices:

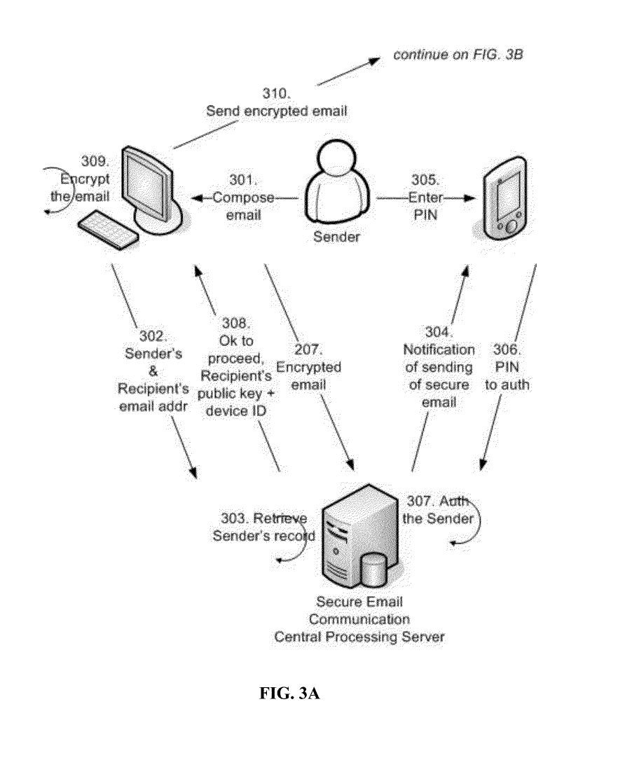

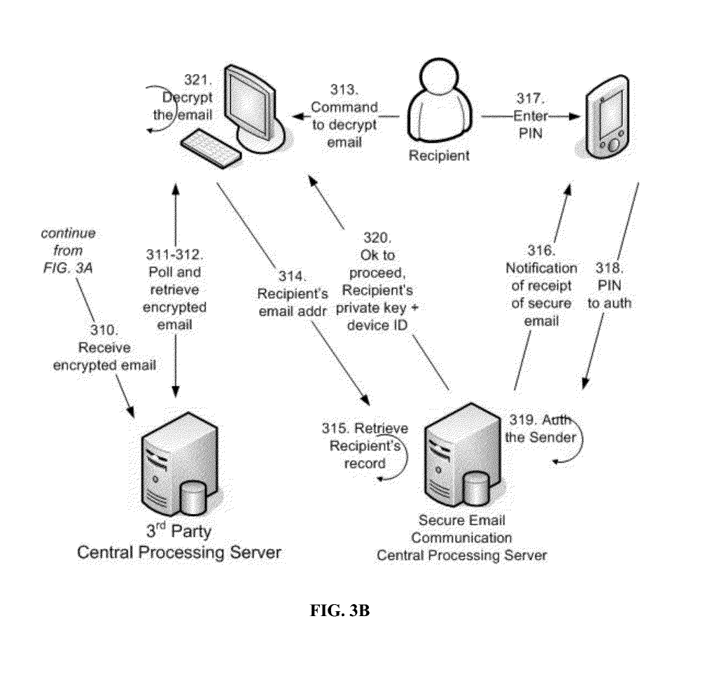

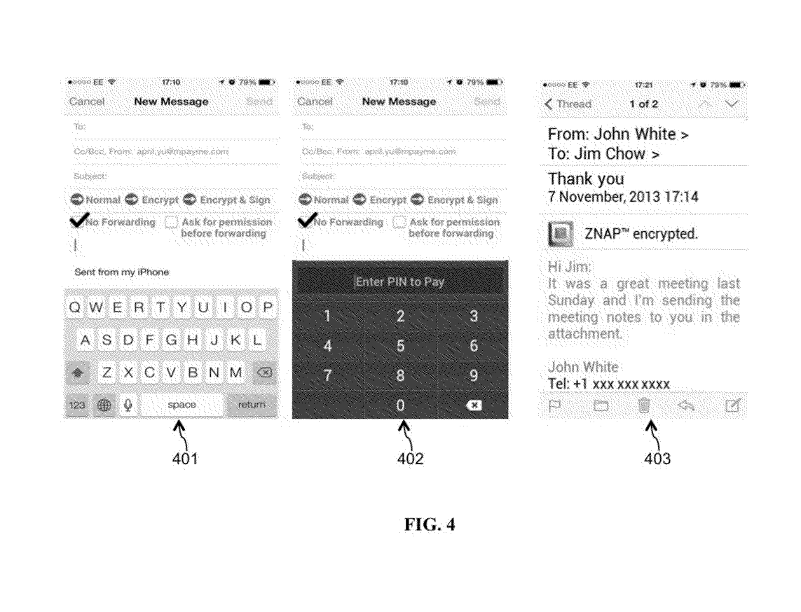

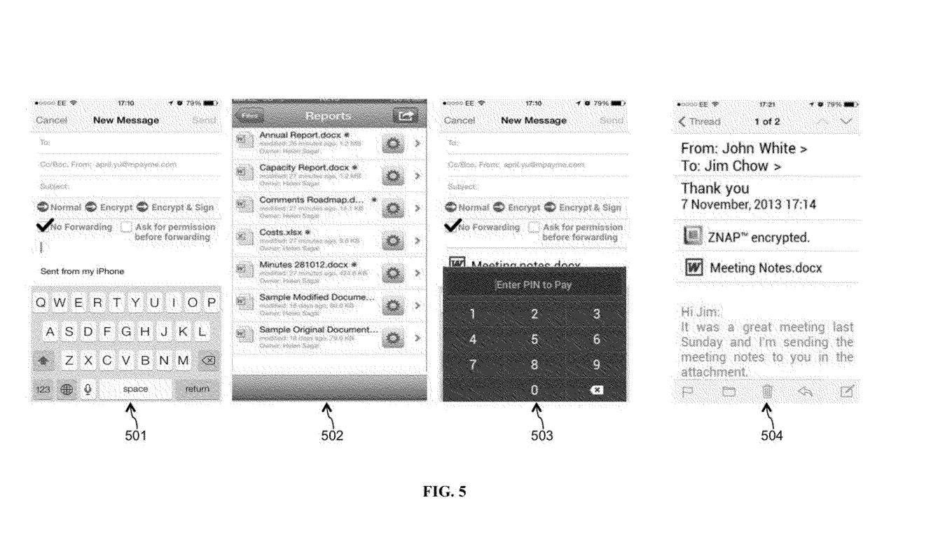

Referring to FIGS. 3A and 3B. The process of sending and receiving emails using computing devices involving a sender and a recipient, both registered users in the secure email communication system, comprising the following steps:

1. (301) Using a sender's computing device running a browser software application (accessing a web-based email client) or email client software application installed with the secure email software plug-in component, or the specially developed secure email software application, the sender composes an email message and specifies the email address of the recipient. In the user interface provided by the secure email software plug-in component or the secure email software application, the sender can also select the email forwarding restriction option, and commands to encrypt the email and deliver it using the secure email communication system.
2. (302) The secure email software plug-in component of the browser software application or the email client software application, or the secure email software application communicates with the first central processing server, sending a data message including the sender's email address, the recipient's email address, and a data indicating that a secure email is to be delivered through the secure email communication system.
3. (303) The first central processing server receives the data message, uses the sender's email address to find and retrieve the sender's user account record from its database, then in turn retrieves the information of the sender's paired mobile communication device from the sender's user account record.
4. (304) The first central processing server sends the sender's paired mobile communication device a data message indicating that a secure email is to be delivered through the secure email communication system.
5. (305) The sender's paired mobile communication device receives the data message, launches the secure email mobile application, prompting the sender to enter her security PIN in the secure email mobile application user interface to be cryptographically hashed by the secure email mobile application.
6. (306) The sender enters her security PIN. The sender's mobile communication device running the secure email mobile application sends the cryptographically hash of the sender's security PIN and the sender's mobile communication device's device ID to the first central processing server.
7. (307) The first central processing server authenticates the sender using the cryptographically hash of security PIN and the sender's mobile communication device's device ID received.
8. (308) Upon positive authentication, the first central processing server finds and retrieves the recipient's user account record using the recipient's email address from its database, and in turn retrieves the recipient's public key and the device ID of the recipient's mobile communication device from the recipient's user account record. The first central processing server sends the sender's computing device a data message including the recipient's public key and the device ID of the recipient's mobile communication device, and a data indicating to the sender's computing device to proceed.
9. (309) The secure email software plug-in component of the browser software application or the email client software application, or the secure email software application running in the sender's computing device encrypts the email message using the received recipient's public key and the device ID of the recipient's mobile communication device. The secure email software plug-in component or the secure email software application places the encrypted email message as the inline content or attachment of the email being displayed in the browser software application (in the web-based email client) or the email client software application, or the secure email software application, and notifies the sender that the email is ready to be sent through a message displayed in its user interface (i.e. a popup dialog box).
10. (310) The sender commands the browser software application (the web-based email client) or the email client software application, or the secure email software application to send the encrypted email. The browser software application (the web-based email client) or the email client software application, or the secure email software application sends the encrypted email to the third party central processing server running the email server application that hosts the recipient's email address as specified in the email under the SMTP protocol.
11. (311) The recipient commands the browser software application (accessing the web-based email client) or the email client software application, or the secure email software application running in the recipient's computing device to poll the email server application running in the third party central processing server under (not applicable to web-based email client) the POP3 or IMAP protocol for new email.
12. (312) The browser software application (accessing the web-based email client) or the email client software application, or the secure email software application running in the recipient's computing device retrieves the encrypted email sent by the sender from the third party central processing server.
13. (313) The recipient commands the secure email software plug-in component of the browser software application or the email client software application, or the secure email software application to decrypt the encrypted email received.
14. (314) The secure email software plug-in component of the browser software application or the email client software application, or the secure email software application communicates with the first central processing server, sending a data message including the recipient's email address, and a data indicating that a secure email is received and requested to be decrypted.
15. (315) The first central processing server receives the data message, uses the recipient's email address to find and retrieve the recipient's user account record from its database, then in turn retrieves the information of the recipient's paired mobile communication device from the recipient's user account record.
16. (316) The first central processing server sends the recipient's paired mobile communication device a data message indicating that a secure email is received and requested to be decrypted.
17. (317) The recipient's paired mobile communication device receives the data message, launches the secure email mobile application, prompting the recipient to enter her security PIN in the secure email mobile application user interface to be cryptographically hashed by the secure email mobile application.
18. (318) The recipient's mobile communication device running the secure email mobile application sends the cryptographically hash of the recipient's security PIN, and the recipient's mobile communication device's device ID to the first central processing server.
19. (319) The first central processing server authenticates the sender using the cryptographically hash of security PIN and the recipient's mobile communication device's device ID received.
20. (320) Upon positive authentication, the first central processing server retrieves from the recipient's user account record the recipient's private key and the device ID of the recipient's mobile communication device. The first central processing server sends the recipient's computing device a data message including the recipient's private key and the device ID of the recipient's mobile communication device, and a data indicating to the recipient's computing device to proceed.
21. (321) The secure email software plug-in component of the browser software application or the email client software application, or the secure email software application running in the recipient's computing device decrypts the received encrypted email using the recipient's private key and the device ID of the recipient's mobile communication device, and places the decrypted email message as the inline content or attachment of the email being displayed in the browser software application (in the web-based email client) or the email client software application, or the secure email software application.

In accordance to other embodiments, the secure email communication system allows a sender to send a secure email using a mobile communication device and a recipient to receive the secure email using a computing device following substantially the same process steps as described above. Similarly, a sender can also use a computing device in sending a secure email while a recipient uses a mobile communication device to receive the secure email.

Restriction on Email Forwarding:

An email sender in the secure email communication system can specify restriction on email forwarding using the user interface of the secure email mobile application running in her paired mobile communication device, the secure email software plug-in component of the browser software application or the email client software application, or the secure email software application running in her computing device when composing and sending a secure email. In accordance to one embodiment, the user selections of the restriction on email forwarding include: 1.) no restriction on forward; 2.) no forwarding; and 3.) ask for permission before forward. The selection of the restriction on email forwarding is included as a meta data of the secure email delivered through the secure email communication system.

The secure email mobile application running in a paired mobile communication device, the secure email software plug-in component of the browser software application or the email client software application, or the secure email software application running in a computing device checks the meta data of a secure email for permission for forwarding before the secure email is being encrypted and forwarded through the secure email communication system. If the meta data indicates no forwarding or permission for forwarding is not yet granted, the secure email mobile application, the secure email software plug-in component, or the secure email software application denies the forwarding action of the secure email.

If the option 3.) ask for permission before forward is selected, the recipient can request for the forwarding permission by indicating as such and the forwardee's email address using the secure email mobile application running in her paired mobile communication device, the secure email software plug-in component of the browser software application or the email client software application, or the secure email software application running in her computing device. The secure email mobile application, secure email software plug-in component, or the secure email software application sends a data message including the forwardee's email address and a data indicating the request for forwarding permission to the first central processing server. The first central processing server then relays the data message to the sender's mobile communication device running the secure email mobile application. If the sender approves the request, the secure email mobile application running in the sender's mobile communication device sends another data message indicating such approval to the first central processing server. The first central processing server then relays the data message back to the recipient's mobile communication device or computing device. The secure email mobile application running in the recipient's mobile communication device, secure email software plug-in component, or the secure email software application running in recipient's computing device modifies the meta data of the secure email to be forwarded, indicating the permission for forwarding is granted, before forwarding the secure email.

Signing Attached Document:

In accordance to another aspect of the presently claimed secure email communication system, a sender can electronically sign a document to be attached in a secure email to be delivered through the secure email communication system using the secure email mobile application running in the sender's mobile communication device, secure email software plug-in component, or the secure email software application running in sender's computing device. When commanded by the sender, the secure email mobile application, secure email software plug-in component, or the secure email software application generates a barcode, which can be a QR code, that includes at least the encoded data referencing the identity of the signer (the sender in this case) and the time of signing. The barcode is then embedded in the document being electronically signed before attaching to the secure email to be sent. The barcode data is also stored in the first central processing server for later verification.

An attached document can be signed by multiple parties with the barcode aggregating the multiple signatory information as the secure email with the attached document is being sent, replied, and forwarded between the sender, recipient, and forwardees. During each signing, the secure email mobile application, secure email software plug-in component, or the secure email software application overwrites the original barcode with a new barcode with the additional encoded information of the new signer and signing time.

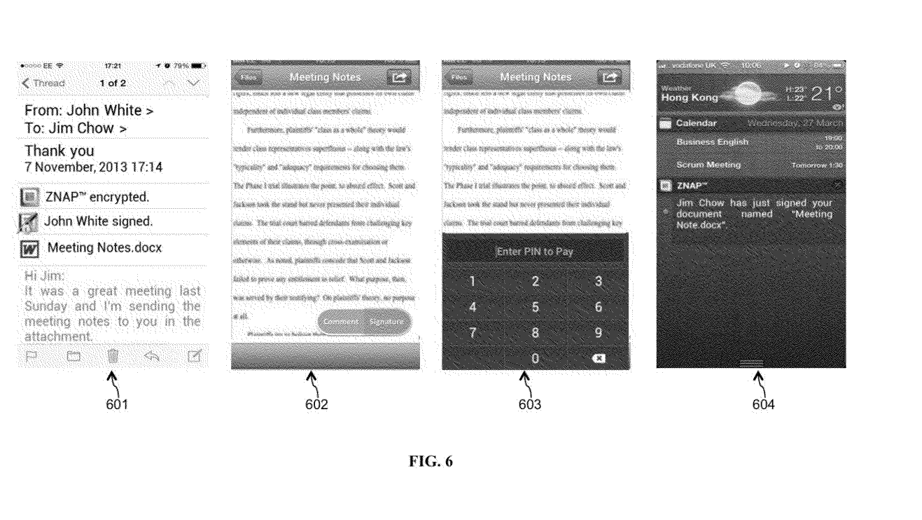

To illustrate, referring to FIG. 6, which shows the user interface of the secure email mobile application running in the recipient's mobile communication device (screenshots 601-603 of the transitioning user interface) being used to counter-sign an attached document in a secure email received, and the user interface of the secure email mobile application running in the sender's mobile communication device (screenshot 604 of the user interface) being used to receive a message indicating the recipient's signing of the attached document. Once the recipient signs the attached document, the secure email mobile application running in the recipient's mobile communication device sends a data message to the first central processing server indicating the recipient's signing of the attached document. The first central processing server then relays the data message to the sender's mobile communication device to notify the sender of the same.

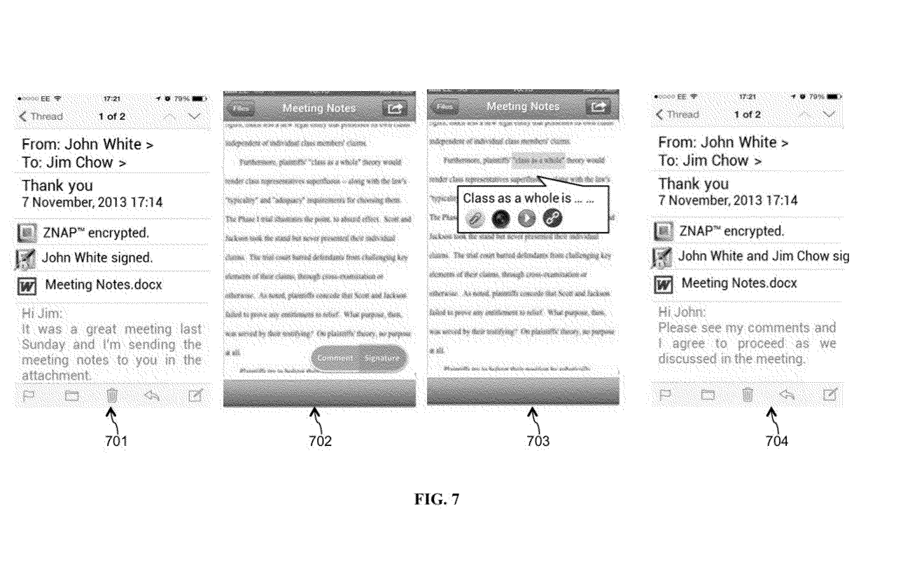

In addition to counter-signing an attached document, the recipient can also insert comments in the attached document to be replied back to the sender. FIG. 7 shows the user interface of the secure email mobile application running in the recipient's mobile communication device (screenshots 701-703 of the transitioning user interface) being used to counter-sign and comment an attached document in a secure email received, and the user interface of the secure email mobile application running in the sender's mobile communication device (screenshot 704 of the user interface) being used to receive a reply email from the recipient with the counter-signed and commented attached document. In this case, after the counter-signing and commenting the attached document, the attached document along with the secure email being attached to are encrypted and sent through the secure email communication system following the same aforesaid process described above and in FIGS. 2A and 2B.

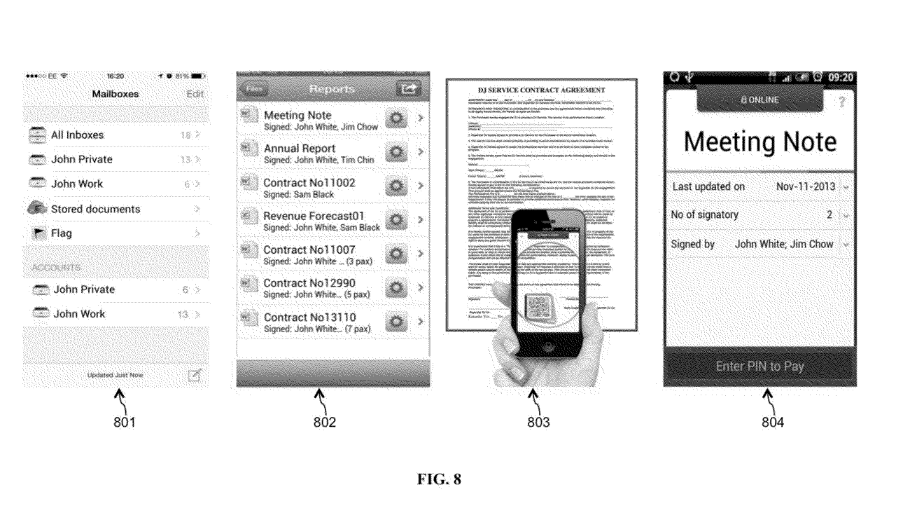

A signed document can be verified by optically capturing the barcode embedded in the signed document using a paired mobile communication device equipped with a camera or optical scanner and running the secure email mobile application. Once the barcode is optically captured, the secure email mobile application decodes the barcode and sends the decoded data to the first central processing server for verification. Upon a positive verification, the first central processing server replies with the signature information including the last update date of the barcode, the number of signatory, and the identity(ies) of the signer(s). FIG. 8 shows a screenshot 803 of the user interface of the secure email mobile application running in a paired mobile communication device capturing the signature barcode, and a screenshot 804 of the user interface of the secure email mobile application showing the signatory information after the processing of the signature barcode.

The embodiments disclosed herein may be implemented using general purpose or specialized computing devices, mobile communication devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, mobile communication devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Exemplary embodiments of mobile communication devices include, but are not limited to, mobile telephones, mobile telephones with personal computer like capability (commonly referred to as “smartphones”), electronic personal digital assistants (PDAs), portable computers with wired or wireless wide-area-network and/or telecommunication capability such as tablet personal computers and “netbook” personal computers.

Exemplary embodiments of computing devices include, but are not limited to, general purpose personal desktop computers, general purpose personal laptop computers, other portable computers with wired or wireless wide-area-network and/or telecommunication capability such as tablet personal computers and “netbook” personal computers.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A computer implemented method for sending and receiving secure emails, comprising:
allowing composition of a email in a sender's mobile communication device to be sent to a recipient, wherein the sender's mobile communication device being equipped with one or more processors, wherein the sender's mobile communication device is uniquely associated with the sender's user account record, wherein the sender's user account record including at least an authentication information of the sender, and wherein the sender's user account record being stored in a first central processing server;
authenticating the sender;
encrypting, by the sender's mobile communication device, the email to generate a first encrypted email using at least a device identification of the sender's mobile communication device;
sending, by the sender's mobile communication device, the first encrypted email to the first central processing server;
decrypting and re-encrypting, by the first central processing server, the first encrypted email to generate a second encrypted email; and
sending, by the first central processing server, the second encrypted email to the recipient email server according to the recipient email address specified in the email.

2. The method of claim 1, wherein the sender authentication comprises:
receiving a security PIN in the sender's mobile communication device;
sending the security PIN to the first central processing server; and
matching the security PIN with the authentication information in the sender's user account record.

3. The method of claim 1, wherein the encryption of the email to generate the first encrypted email further comprises using a private key of sender in addition to the device identification of the sender's mobile communication device to encrypt the email.

4. The method of claim 1, wherein the decryption and re-encryption of the first encrypted email to generate the second encrypted email comprises:
using a copy of the device identification of the sender's mobile communication device that is previously stored in the first central processing server to decrypt the first encrypted email; and
using a copy of a device identification of the recipient's mobile communication device that is previously stored in the first central processing server to re-encrypt the decrypted first encrypted email.

5. The method of claim 3, wherein the decryption and re-encryption of the first encrypted email to generate the second encrypted email comprises:
using a public key of the sender and a copy of the device identification of the sender's mobile communication device that are previously stored in the first central processing server to decrypt the first encrypted email; and
using a public key of the recipient and a copy of a device identification of a recipient's mobile communication device that are previously stored in the first central processing server to re-encrypt the decrypted first encrypted email.

6. The method of claim 1, further comprising:
receiving the second encrypted email in the recipient's mobile communication device, wherein the recipient's mobile communication device being equipped with one or more processors, wherein the recipient's mobile communication device is uniquely associated with the recipient's user account record, wherein the recipient's user account record including at least an authentication information of the recipient, and wherein the recipient's user account record being stored in a first central processing server;
authenticating the recipient; and
decrypting, by the recipient's mobile communication device, the second encrypted email using at least a device identification of the recipient's mobile communication device.

7. The method of claim 6, wherein the recipient authentication comprises:
receiving a security PIN in the recipient's mobile communication device;
sending the security PIN to the first central processing server; and
matching the security PIN with the authentication information in the recipient's user account record.

8. The method of claim 1, further comprising:
allowing an attachment of a document to the email being composed in the sender's mobile communication device;
allowing an electronic signing of the attached document by embedding a barcode in the attached document, wherein the barcode including encoded information of a signer.

9. A computer implemented method for sending and receiving secure emails, comprising:
allowing composition of a email in a sender's computing device to be sent to a recipient;
authenticating the sender using a sender's mobile communication device, wherein the sender's mobile communication device being equipped with an optical scanner or camera and one or more processors, wherein the sender's mobile communication device is uniquely associated with the sender's user account record, wherein the sender's user account record including at least an authentication information of the sender, and wherein the sender's user account record being stored in a first central processing server;
sending, by the first central processing server, a device identification of the recipient's mobile communication device to the sender's computing device;
encrypting, by the sender's computing device, the email to generate an encrypted email using at least the device identification of the recipient's mobile communication device;
sending, by the sender's computing device, the encrypted email to the recipient email server according to the recipient email address specified in the email.

10. The method of claim 9, wherein the sender authentication comprises:
receiving a security PIN in the sender's mobile communication device;
sending the security PIN to the first central processing server; and
matching the security PIN with the authentication information in the sender's user account record.

11. The method of claim 9, further comprising:
sending, by the first central processing server, a public key of the recipient to the sender's computing device;
wherein the encryption of the email to generate the encrypted email further comprises using the public key of the recipient in addition to the device identification of the recipient's mobile communication device to encrypt the email.

12. The method of claim 9, further comprising:
receiving the encrypted email in the recipient's computing device;
authenticating the recipient using the recipient's mobile communication device, wherein the recipient's mobile communication device being equipped with one or more processors, wherein the recipient's mobile communication device is uniquely associated with the recipient's user account record, wherein the recipient's user account record including at least an authentication information of the recipient, and wherein the recipient's user account record being stored in a first central processing server; and
decrypting, by the recipient's computing device, the encrypted email using at least the device identification of the recipient's mobile communication device.

13. The method of claim 12, wherein the recipient authentication comprises:
receiving a security PIN in the recipient's mobile communication device;
sending the security PIN to the first central processing server; and
matching the security PIN with the authentication information in the recipient's user account record.

14. The method of claim 9, further comprising:
allowing an attachment of a document to the email being composed in the sender's computing device;
allowing an electronic signing of the attached document by embedding a barcode in the attached document, wherein the barcode including encoded information of a signer.
